(19) United States
(12) Patent Application Publication
(10) Pub. No.: US 2008/0101664 A1
(43) Pub. Date: May 1, 2008

(54) Non-Contact Optical Means And Method For 3D Fingerprint Recognition

(76) Inventor: Asher Perez, Jerusalem (IL)

Correspondence Address: CANTOR COLBURN, LLP, 20 Church Street, 22nd Floor, Hartford, CT, 06103, US

(21) Appl. No.: 11/660,019

(22) PCT Filed: Aug. 9, 2005
(86) PCT No.: PCT/IL05/00856

§ 371 Date: Sep. 4, 2007

Related U.S. Application Data
(60) Provisional application No. 60/599,557, filed on Aug. 9, 2004.

(51) Int. Cl. G06K 9/00; G06K 9/40

(52) U.S. Cl. 382/125; 382/255

(57) ABSTRACT

The present invention discloses a method of recognizing 3D fingerprints by contact-less optical means. The novel method comprising inter alia the following steps of obtaining an optical contact-less means for capturing fingerprints, such that 3D optical images, selected from a group comprising minutia, forks, endings or any combination thereof are provided; obtaining a plurality of fingerprints wherein the images resolution of said fingerprints is not dependent on the distance between a camera and said inspected finger; correcting the obtained images by mis-focal and blurring restoring; obtaining a plurality of images, preferably 6 to 9 images, in the enrolment phase, under various views and angles; systematically improving the quality of the field depth of said images and the intensity per pixel; and, disengaging higher resolution from memory consumption, such that no additional optical sensor is required.

### FIELD AND BACKGROUND OF THE INVENTION

The present invention generally relates to a non-contact optical means and a method for 3D fingerprint recognition.

The patterns and geometry of fingerprints are different for each individual and they are unchanged with body grows and time elapses. The classification of fingerprints is usually based on certain characteristics such as arch, loop or whorl. The most distinctive characteristics are the minutiae, the forks, or endings found in the ridges and the overall shape of the ridge flow.

Various patents show methods for recognizing fingerprints. Hence, U.S. App. No. 2004/234111 to Mueller discloses a method for testing fingerprints whose reference data are stored in a portable data carrier.

Fingerprints are extremely accurate identifiers since they rely on un-modifiable physical attributes, but the recognition of their uniqueness requires specialist input devices. These devices are not always compatible with standard telecommunications and computing equipment. Furthermore, the cost related to these devices creates a limitation in terms of mass-market acceptance.

There thus remains a long felt need for a cost effective method of 3D fingerprint recognition using a non-contact optical means, which has hitherto not been commercially available.

### SUMMARY OF THE INVENTION

The object of the present invention is thus to provide a non-contact optical means and a method for 3D fingerprint recognition. Said method comprises in a non-limiting manner the following steps: obtaining an optical non-contact means for capturing fingerprints, such that 3D optical images of fingerprint characteristics, selected from a group comprising minutia, forks, endings or any combination thereof are provided; obtaining a plurality of fingerprint images wherein the image resolution of said fingerprint images is independent of the distance between camera and said inspected finger; correcting the obtained images by mis-focal and blurring restoring; obtaining a plurality of images, preferably between 6 to 9 images, in the enrolment phase, under various views and angles; systematically improving the quality of the field depth of said images and the intensity per pixel; and, disengaging higher resolution from memory consumption, such that no additional optical sensor is required.

It is in the scope of the present invention to provide a method of utilizing at least one CMOS camera; said method is being enhanced by a software based package comprising: capturing image with near field lighting and contrast; providing mis-focus and blurring restoration; restoring said images by keeping fixed angle and distance invariance; and, obtaining enrolment phase and cross-storing of a mathematical model of said images.

It is also in the scope of the present invention to provide a method of acquiring frequency mapping of at least a portion of fingerprints regions, by segmenting the initial image in a plurality of regions, and performing a DCT or Fourier Transform; extracting the outer finger contour; evaluating the local blurring degradation by performing at least one local histogram in the frequency domain; increasing blurring arising from a quasi-non spatial phase de-focused intensity image; estimating the impact of said blurring and its relation to the degree of defocusing Circle Of Confusion (COC) in different regions; ray-tracing the image adjacent to the focus length and generating quality criterion based on Optical Precision Difference (OPD); modelizing the Point Spread Function (PSF) and the local relative positions of COC in correlation with the topological shape of the finger; and, restoring the obtained 3D image, preferably using discrete deconvolution, this may involve either inverse filtering and/or statistical filtering means.

It is further in the scope of the present invention to provide a method of applying a bio-elastical model of a Newtonian compact body; a global convex recovering model; and, a stereographic reconstruction by matching means.

It is yet also in the scope of the present invention to provide a method for building a proximity matrix of two sets of features wherein each element is of a Gaussian-weighted distance; and, performing a singular value decomposition of the correlated proximity G matrix.

It is another object of the present invention to provide method of distinguishing between a finger image captured at the moment of recognition, and an image captured on earlier occasion, further comprising comparing the reflectivity of the images as a function of surrounding light conditions comprising: during enrolment, capturing pictures being in each color channel and mapping selected regions; performing a local histogram on a small region for each channel; setting a response profile, using external lightning modifications for each fingerprint, according to the different color channels and the sensitivity of the camera device; obtaining acceptance or rejection of a candidate, and comparing the spectrum response of a real fingerprint with suspicious ones.

It is in the scope of the present invention to provide a method of obtaining a ray tracing means; generating an exit criterion based on an OPD; acquiring pixel OTF related to detector geometry; calculating sampled OTFs and PSFs; calculating digital filter coefficients for chosen processing algorithm based on sampled PSF set; calculating rate operators; processing digital parameters; combining rate merit operands with optical operands; and modifying optical surfaces.

It is also in the scope of the present invention to provide a method of improving the ray-tracing properties and pixel redundancies of the images, comprising inter alias: redundancy deconvolution restoring; and determining a numerical aspheric lens, adapted to modelize blurring distortions.

It is yet in the scope of the present invention to provide a system for identification of fingerprints, comprising: means for capturing images with near field lighting; means for mis-focus and blurring restoration; means for mapping and projecting of obtained images; and, means for acquiring an enrolment phase and obtaining cross-storage of the mathematical model of said images.

### BRIEF DESCRIPTION OF THE FIGURES

In order to understand the invention and to see how it may be implemented in practice, a preferred embodiment will now be described, by way of non-limiting example only, with reference to the accompanying drawing, in which

FIG. 1 schematically presenting a schematic description of the cellular configuration according to one simplified embodiment of the present invention;

FIG. 2 schematically presenting a description of the PC configuration according to another embodiment of the present invention;

FIG. 3 still schematically presenting a description of the flowchart according to another embodiment of the present invention; and,

FIG. 4 schematically presenting an identification phase according to yet another embodiment of the present invention.

### DETAILED DESCRIPTION OF THE EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a method of recognizing 3D fingerprints by non-contact optical means.

The present methodology includes a plurality of steps in a non exclusive manner:

The first step is the “image acquisition” or image capture. In this part of the process, the user places his finger near the camera device. An image of the finger is captured and the analysis of the image can be processed.

This way to acquire the image is different from conventional fingerprint devices as the image of the finger is captured without any physical contact. In alternative technologies, the finger is physically in contact with a transparent glass plate or any sensitive surface, also referred to as a scanner.

By using this technology, selected images must verify basic requirements, such as lighting, contrast, blurring definition. Only images where central point is observed may be selected.

The present technology allows getting a wide range of fingerprint images regardless of the distance existing between any regions of the finger, as a 3D body the curvature of the finger has to be considered, and the camera component.

Taking into account optical restrictions and mis-position of the finger, such as focal length of the lens, environmental light conditions, the present technology is able to correct images with mis-focal and blurring degradation.

This second step is dedicated to the reconstruction of an image captured at short distances and exhibiting blurring degradation coming from de-focusing. Scaling of the image in order to adjust the optical precision, i.e. number of pixel per area, is also realized.

Specific procedure for the image reconstitution is detailed hereafter.

One of the most critical steps for fingerprint recognition consists in the extraction of the mathematical model, skeletonized wired representation of the finger with determination of the raw minutia. In order to get a good reproducible mathematical model, one has to limit as far as possible the number of degrees of freedom of the finger, number of degrees of freedom is commonly supposed to be 6.

Contrarily to contact technologies where naturally most of degrees of freedom are frozen, only translational and rotation movement remains, the present technology is dedicated to take into account far more complicated images where hard topological aberration appears. As an illustration, let's point that ridges in regions with sharp gradient appear closer than there are in real have to be rescaled.

As a consequence, non-contact images, which are by nature 3D images, don't keep angles invariance and distance scalability; this situation may complicate any reproducibility of the mathematical model.

At this level, the present technology restitutes projected 3D images that keep angle and distance invariance. These new images are equivalent to the ones used by conventional contact scanners.

A series of procedures and algorithms allowing this kind of topological projections are proposed. Different algorithms are detailed hereafter.

Capture phase occur in different steps of the finger recognition: enrolment, verification and identification.

In order to improve the matching of an image during the verification or identification phase, one has to get a sub-database where fingerprint identification of a given finger has been done. In general, during the enrolment phase, three different images of the same fingerprint are processed by restitution of a mathematical model and a correlation weight is built in order to link them together. Here, in the case of non-contact images, the enrolment phase consists of several images, typically 6-9, under different views and angles. A cross-linking similitude algorithm is then processed in order to restitute a stereo-scopic view of the image.

Further, using the topological 3D reconstructed image, the different images will be projected on the finger shape. The overall sub-database of images, and their mathematical model templates, obtained in that way will be used for further recognition.

For applications requiring only verification procedure, “1:1 technology”, the enrolment phase will include at least one true 2D image, fingerprint captured by the use of a contact reader of similar quality as the one used in the non-contact reader. In that way, the reference 2 dimensional restitutes fundamental parameters like depth of fields, scanner resolution, angular tolerance and local periodicity of ridges vs. valleys.

According to another embodiment of the present invention, this technology calibrates locally the camera sensor parameters such as local contrast, lighting, saturation for an optimal extraction of the fingertip papillary lines.

The fingerprint is composed of topological details such as minutiae, ridges and valleys, which form the basis for the loops, arches, and swirls as seen on fingertip.

The present invention discloses a method for the capture of minutiae and the acquisition of the ridges according to one embodiments of the present invention. This method is especially useful on the far field diffractive representation or Fourier transform of the fingerprint structure.

The procedure comprises inter-alias the following steps:

1. Extraction of the limits of the Finger in the image

A series of image processing filters are applied for extracting the finger form:
a. RGB Channel Algorithms
b. Histogram in Red
c. Gray-scale decimation
d. White noise filters and low band.
e. Mask illumination
f. ROI algorithm
g. Local periodicity

2. Acceptation or rejection of an image

3. Algorithm for the central point determination

4. Image extraction at a small radius around the central point. This step consists on a series of image processes.

5. Multi-zoning and local momentum algorithm

6. Edging extraction

7. Local Fourier Block analysis

According to yet another embodiment of the present invention, one of the major requirements in on-fly image analysis is the confidence to get a well-focused image in order to minimize as far as possible blurring aberrations occurring in different regions of the image.

In order to achieve this goal, a series of procedures is proposed to estimate the quality of the input image and if needed increase the quality by providing generic corrections coming from de-focusing of the image.

The present invention discloses a method of providing a generic procedure that systematically improves the quality of the field depth of the image and the intensity per pixel.

For achieving this task, an on-fly estimation of the image defocusing using indicators both in the real space and in the frequency Fourier representation is provided. The key point, in order to estimate this degradation, is to get a good understanding of the Point Spread Function (PSF).

For any image taken by a CMOS or CCD camera sensor at small distance sensitively the scale of the focal length, because of the strong local difference in the topology of the finger; some regions in the image are merely de-focused and local blurring appear.

Topologically, it appears that the image is constituted by several layered islands where the image quality is different. For a well focused image with a fingerprint, the local texture in the image is globally homogeneous, alternatively succession of ridges and valley with local topological discontinuities, and that its frequency profile is well defined.

On the contrary, for de-focused regions, the blurring generates low pass filters and uniform diffusive textured regions.

As soon as any sub-region in the image can be isolated with a well-defined texture and with the whole panel of spatial frequencies, it comes possible to correct the entire region of interest (ROI). Even if, large parts of the ROI are blurred, the basic assumption of local phase de-focusing makes the correction possible.

For achieving this task, an on-fly treatment of the defocusing of the image is provides using indicators both in the real space and in the frequency Fourier representation. The key point, in order to estimate this degradation, is to define a robust generic model of the PSF.

The major steps of the methodology are detailed as follows:
1. Start with a given optical surface under specified operating conditions such as range of the wavelength, field of view of the image, local contrast.
2. Segmentation of the initial image in several regions and performance of a DCT or Fourier Transform in order to get a frequency mapping of each regions.

Parameters of the JPEG image are used in order to extract local parameters and the local granulometry.
3. Extraction of the finger shape and contouring. Local histogram in the frequency domain is performed in order to evaluate the local blurring degradation.
4. Blurring arises from a quasi-non spatial phase de-focused intensity image. In the different regions, the impact of the blurring and its relation with the degree of defocusing Circle Of Confusion (COC) is estimate.
5. Operate ray-tracing algorithm near the focus length and quality criterion based on Optical Precision Difference (OPD) is generated. The PSF and the local relative positions of COC in correlation with the topological shape of the finger are modelized.
6. Using discrete deconvolution, the restoration of the final 3D image can be proceeding. This step involves either inverse filtering and/or statistical filtering algorithm.

For harder de-focused images, several improvements are proposed, taking into account ray-tracing properties and treatment of pixel redundancies.

De-focused images generated slightly phase local blurring. Precision required in order to extract local features e.g. minutia, ridges and valleys, can be done typically with low integrated pixels sensors.

Using present and further low-cost CMOS or CCD camera sensor with massive integrated pixels matrices e.g. Mega Pixel and more, the restoration algorithm based on de-convolution can be sensitively improved. We claim that the expected PSF can be refined using over sampling algorithm.

Using local ray-tracing algorithm, the light intensity collected on each pixel allows getting better information on the PSF and the Optical Transfer Function (OTF). We propose to use this redundancy of local information in order to refine the weight of each pixel and to get the proper PSF.

De-focused image can be improved using over sampled information and ray-tracing algorithm by means of numeric filter of aspherical optics.

The model of PSF and COC remains well defined for a wide variety of fingerprint origin images. For well-focused images, fingerprint information requires typically no more than 100K pixels. Basically, for Mega-pixel sensor, this additive information can be used to modelize local ray-tracing and estimate the PSF and aberrations leading to blurring.

These aberrations can lead to the determination of a numerical aspheric lens which modelizes blurring distortions. Using de-convolution restoration, well-focused image can be retrieved.

The procedure can be enounced as follows:
1. Start with a given optical surface under specified operating conditions such as range of the wavelength, field of view of the image or local contrast.
2. Operate a ray tracing algorithm and then generate an exit criterion based on an Optical Precision Differences (OPDs).
3. Calculate OTF's.
4. Include pixel OTF related to detector geometry.
5. Calculate sampled OTFs and PSFs.
6. Calculate digital filter coefficients for chosen processing algorithm based on sampled PSF set.
7. Form rate operators that are based on minimizing changes of the sampled PSF and MTF through focus, with field angle, with grey scale, due to aliasing.
8. Digital processing parameters such as amount of processing, processing related image noise.
9. Combine rate merit operands with traditional optical operands such as Seidel type aberrations, RMS errors, into optimization routines and modify optical surfaces.

According to yet another embodiment of the present invention, to build an algorithmic procedure that leads to the creation of pseudo-2D images that keep angle and distance invariance and which remain robust to topological distortions. The following methods are essentially proposed:

1. Bio-elastical model- rigid body of the finger.

A rigid body model is used to determine the 3D orientation of the finger.

2. 3D projection algorithm to the view plane.
a. The perspective projection matrix is build and used to determine the finger print image.
b. The image is corrected using a displacement field computed from an elastic membrane model.
c. Projection is made on a convex 3D free parameter finger model, optimization algorithm using unconstrained non linear Simplex model.

3. Form extraction of the finger by matching algorithm of two stereographic views.

Restoring the third topological dimension taking advantage of small displacements occurring between two successive images of the fingerprint

When the person proceeds to the positioning of his finger onto the optical device, a sequence of captures will be captured. During the adjustment of the finger, central point positioning, in-focal pre-processing at the right distance, the system captures successively two or more images. This procedure allows to get topological information and to determine precisely a 3D meshing of the image. Using a finger convex shape, the stereoscopic image is mapped in order to restitute the right distance between ridges.

A use of an algorithmic procedure based on singular value decomposition of a proximity matrix where restricted features of the two images has been stored is proposed.

Let i and j be two images, containing m features and n features, respectively, which are putted in one-to-one correspondence.

The algorithms consist of three stages:
1. Build a proximity matrix G of the two sets of features where each element is Gaussian-weighted distance.
2. Perform the singular value decomposition of the correlated proximity G matrix where and are orthogonal matrices and the diagonal matrix contains the positive singular values along its diagonal elements in descending numerical order. For m<n, only the first m columns of have any significance.
3. This new matrix has the same shape as the proximity matrix and has the interesting property of sort of “amplifying” good pairings and “attenuating” bad ones.

According to yet another embodiment of the present invention, the methodology distinguishes between a finger image that was captured at the moment of recognition and a finger image captured at a different occasion.

One of the inherent problems in biometric recognition is to verify if the current image is a finger or a digital image. By comparing the reflectivity of the image as a function of light conditions from the surroundings we can verify that the image in fact is a finger and not a fake.

During enrolment, reflectivity of the finger will be collected and a spectrum profile of the finger will be stored. Using the fact that fake fingerprint, either with latex recovering or any artificial material, can be detected by specific spectral signature, we will able to discriminate if the fingerprint is suspicious. In order to achieve this, the following methodology is proposed:
1. During enrolment, the picture captured is analyzed along each color channel and on selected regions. A local histogram for each channel is performed on small region.
2. Using external lightning modifications e.g. flash; change in camera internal parameters, gamma factor, and white balance, a response profile, for each fingerprint, is set according to the different color channels and the sensitivity of the camera device.
3. Comparing the spectrum response of real fingerprint and suspicious ones, either images or latex envelop, will conduct to the acceptation of the rejection of a candidate.

According to yet another embodiment of the present invention, another inherent problem in order to create the mathematical model of the fingerprint is to cope with JPG compression in an environment that has limited CPU and memory resources. A typical way would be to convert the image from JPG to TIFF, BMP or any other format that can be used for recognition. However, as image resolution increases, this procedure becomes more memory consuming. This method proposes a resource-effective procedure that disengages between higher resolution and memory consumption.

The final stage of the thinning algorithm allows getting a binary skeletonized image of the fingerprint. In order to get a more compact binary image, compatible with low CPU requirements, storing the entire binary image in term of smaller topological entities is proposed, taking into account the local behavior of sub-regions. Taking advantage of the parameterization of selected ridges, coming from the previous step concerning the topological stretching of vectorized ridges, the entire mapping of the fingerprint can be realized. This procedure allows building a hierarchy of local segments, minutia, ridges and local periodicity that will be stored for the matching step.

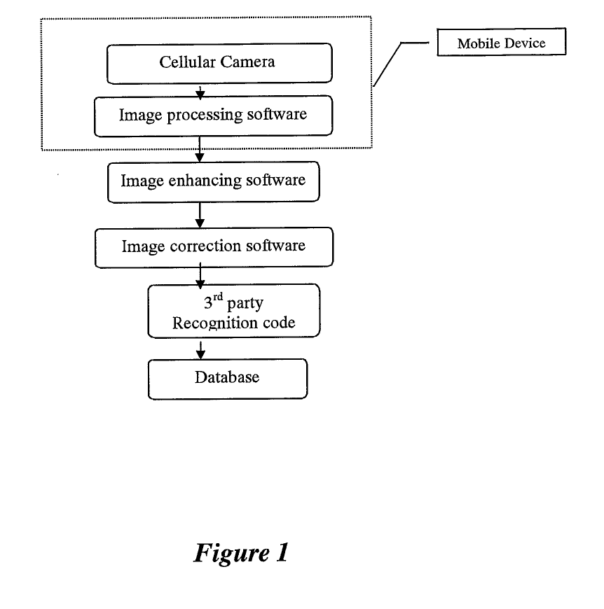

Reference is made now to FIG. 1, presenting a schematic description of the cellular configuration comprising:
1. Cellular Camera—a camera that is part of a mobile device that can communicate voice and data over the internet and/or cellular networks or an accesory to the mobile device.
2. Image Processing algorithms—software algorithms that are delivered as a standard part of the cellular mobile device. This component typically deals with images in a global way, e.g. conducts changes that are relevant for the image in total. These algorithms are typically provided with the cellular camera or with the mobile device.
3. Image Enhacing algorithms—this part enhances images that are captured by the digital camera. The enhancement is local, e.g. relates to specific areas of the image.
4. Image correction algorithms—this part corrects the image for the need of fingerprint recognition. The corrections are made in a way that can be used by standard recogbition algorithms.
5. 3^{rd} Party Recognition algorithm—an off-the-shelve fingerprint recognition algorithm.
6. Database—the database is situated in the mobile device or on a distant location. The database contains fingerprint information regarding previously enrolled persons.

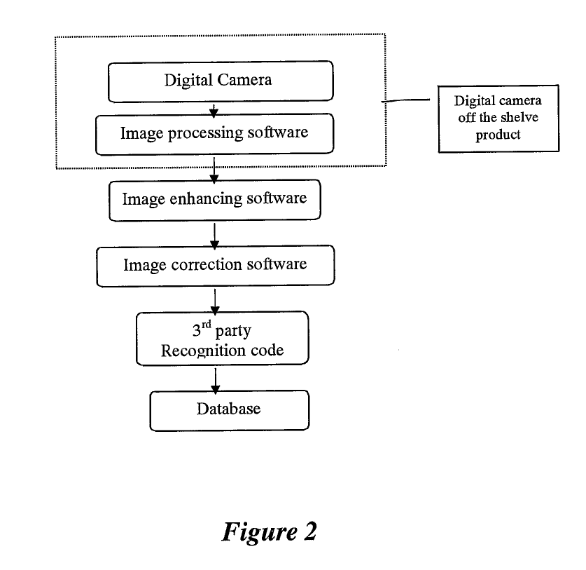

Reference is made now to FIG. 2, presenting a schematic description of the PC configuration comprising:
1. Digital Camera—a camera that is connected to PC.
2. Image Processing algorithms—software algorithms that are delivered as a standard part of the digital camera product package and/or downloaded afterwards over the Internet. This component typically deals with images in a global way, e.g. conducts changes that are relevant for the image in total.
3. Image Enhacing algorithms—this part enhances images that are captured by the digital camera. The enhancement is local, e.g. relates to specific areas of the image.
4. Image correction algorithms—this part corrects the image for the need of fingerprint recognition. The corrections are made in a way that can be used by standard recogbition algorithms.
5. 3^{rd} Party Recognition algorithm—an off-the-shelve fingerprint recognition algorithm.
6. Database—the database is situated in the PC or on a distant location. The database contains fingerprint information regarding previously enrolled persons.

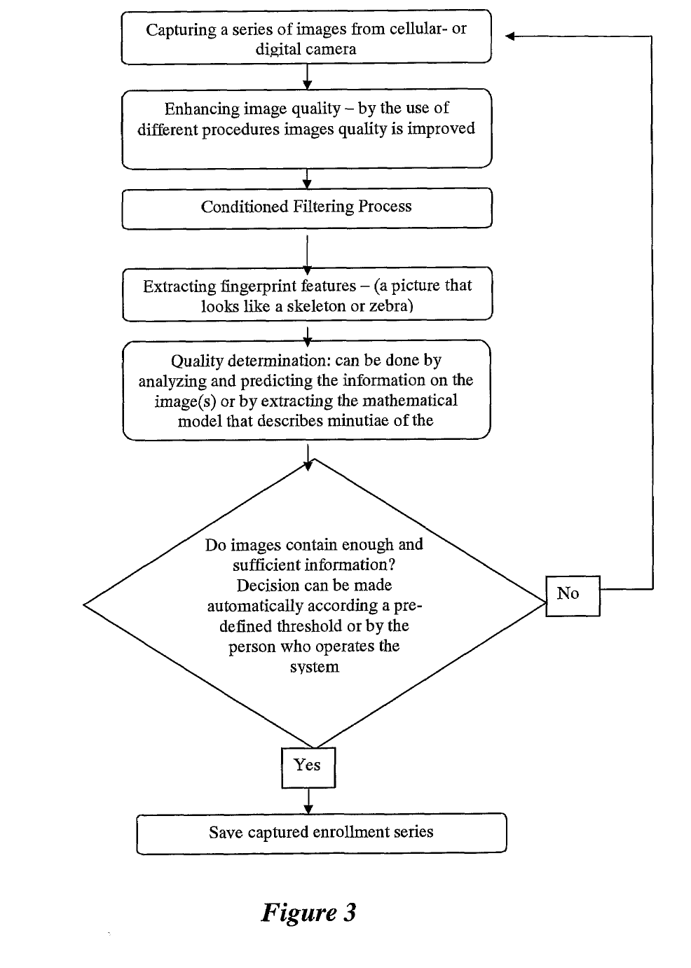

Reference is made now to FIG. 3, presenting a schematic description of the flowchart wherein the fingerprint recognition processes are typically composed of two stages:
1. Enrollment—the initial time that a new entity is added to the database. The following procedure is conducted one or more times.
2. Scaling

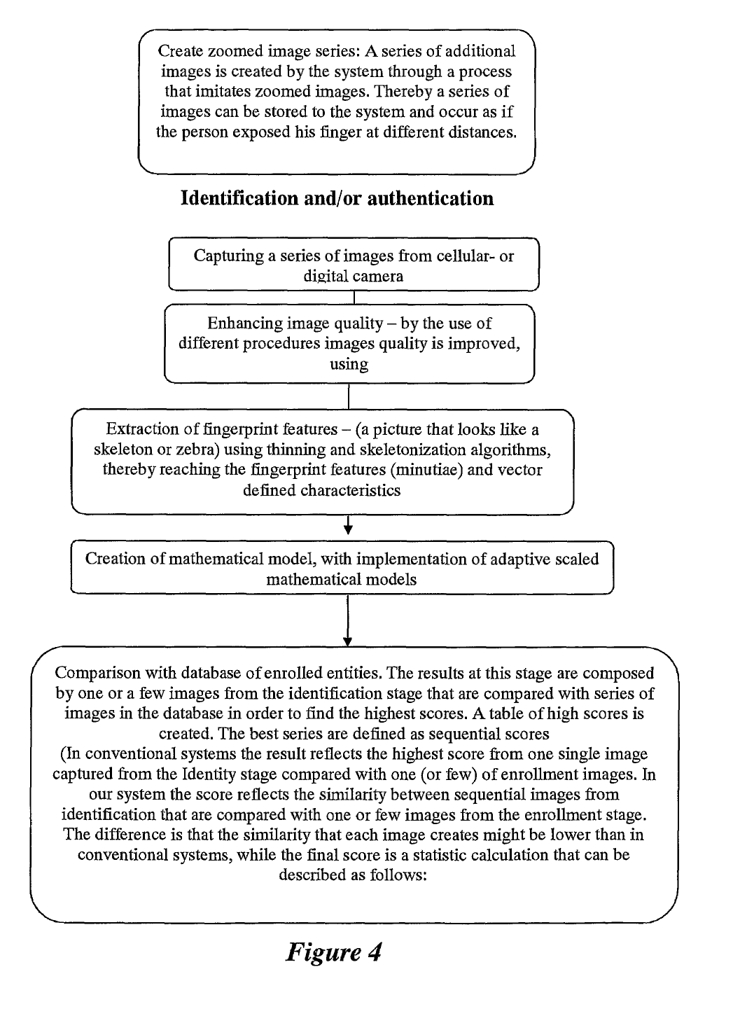

Identification or authentication, as described in FIG. 4, a person approaches the database and uses his finger to get authenticated. Identification refers to a situation where the person provides only the finger, typically defined as one to many, whereas authentication refers to a situation where a person provides his finger and name, typically defined one to one.

1. A method of recognizing 3D fingerprints by non-contact optical means, comprising:
a. obtaining an optical non-contact means for capturing fingerprints, such that 3D optical images, selected from a group comprising minutia, forks, endings or any combination thereof are provided;
b. obtaining a plurality of fingerprints wherein the images resolution of said fingerprints is not dependent on the distance between a camera and said inspected finger;
c. correcting the obtained images by mis-focal and blurring restoring;
d. obtaining a plurality of images, preferably 6 to 9 images, in the enrolment phase, under various views and angles;
e. systematically improving the quality of the field depth of said images and the intensity per pixel; and,
f. disengaging higher resolution from memory consumption, such that no additional optical sensor is required.

2. The method according to claim 1, utilizing at least one CMOS camera; said method is being enhanced by a software based package comprising:
a. capturing image with near field lighting and contrast;
b. providing mis-focus and blurring restoration;
c. restoring said images by keeping fixed angle and distance invariance; and,
d. obtaining enrolment phase and cross-storing of a mathematical model of said images.

3. The method according to claim 2 additionally comprising:
a. acquiring frequency mapping of at least a portion of fingerprints regions, by segmenting the initial image in a plurality of regions, and performing a DCT or Fourier Transform;
b. extracting the outer finger contour;
c. evaluating the local blurring degradation by performing at least one local histogram in the frequency domain;
d. increasing blurring arising from a quasi-non spatial phase de-focused intensity image;
e. estimating the impact of said blurring and its relation to the degree of defocusing Circle Of Confusion (COC) in different regions;
f. ray-tracing the image adjacent to the focus length and generating quality criterion based on Optical Precision Difference (OPD);
g. modelizing the Point Spread Function (PSF) and the local relative positions of COC in correlation with the topological shape of the finger; and,
h. restoring the obtained 3D image, preferably using discrete deconvolution, this may involve either inverse filtering and/or statistical filtering means.

4. The method according to claim 2 comprising:
a. applying an bio-elastical model of a Newtonian compact body;
b. applying a global convex recovering model; and,
c. applying a stereographic reconstruction by matching means.

5. The method according to claim 3 comprising:
a. building a proximity matrix of two sets of features wherein each element is of a Gaussian-weighted distance; and,
b. performing a singular value decomposition of the correlated proximity G matrix.

6. A method of distinguishing between a finger image captured at the moment of recognition, and an image captured on earlier occasion, further comprising comparing the reflectivity of the images as a function of surrounding light conditions comprising:
a. during enrolment, capturing pictures being in each color channel and mapping selected regions;
b. performing a local histogram on a small region for each channel;
c. setting a response profile, using external lightning modifications for each fingerprint, according to the different color channels and the sensitivity of the camera device;
d. obtaining acceptance or rejection of a candidate, and comparing the spectrum response of a real fingerprint with suspicious ones.

7. The method according to claim 6 comprising inter alia:
a. obtaining a ray tracing means;
b. generating an exit criterion based on an OPD;
c. acquiring pixel OTF related to detector geometry;
d. calculating sampled OTFs and PSFs;
e. calculating digital filter coefficients for chosen processing algorithm based on sampled PSF set;
f. calculating rate operators;
g. processing digital parameters;
h. combining rate merit operands with optical operands; and
i. modifying optical surfaces.

8. A method for improving the ray-tracing properties and pixel redundancies of the images, comprising inter alia:
a. redundancy deconvolution restoring; and
b. determining a numerical aspheric lens, adapted to modelize blurring distortions.

9. A system for identification of fingerprints, comprising:
a. means for capturing images with near field lighting;
b. means for mis-focus and blurring restoration;
c. means for mapping and projecting of obtained images; and,
d. means for acquiring an enrolment phase and obtaining cross-storage of the mathematical model of said images.
